(19) United States
(12) Patent Application Publication
(10) Pub. No.: US 2020/0021041 A1
(43) Pub. Date: Jan. 16, 2020

(54) WIRELESS COMMUNICATION APPARATUS WITH COMBINED FREQUENCY AND POLARIZATION DIVERSITY BETWEEN TRANSMITTER AND RECEIVER CHANNELS

(71) Applicant: LIMITED LIABILITY COMPANY "RADIO GIGABIT", Nizhegorodskaya obl. Nizhny Novgorod (RU)

(72) Inventors: Aleksey Andreevich ARTEMENKO, Nizhniy Novgorod (RU); Andrey Viktorovich MOZHAROVSKIY, Nizhniy Novgorod (RU); Sergey Alexandrovich TIKHONOV, Sarov Nizhegorodskaya obl. (RU); Roman Olegovich MASLENNIKOV, Nizhniy Novgorod (RU)

(21) Appl. No.: 16/304,183

(22) PCT Filed: Jun. 5, 2017
(86) PCT No.: PCT/RU2017/050047

§ 371 Date: Sep. 27, 2019

(30) Foreign Application Priority Data
Jun. 24, 2016 (RU) 2016125317

(51) Int. Cl. H01Q 25/00; H01Q 13/10; H01P 1/161; H01Q 21/24

(52) U.S. Cl. CPC H01Q 25/001; H01Q 13/106; H04B 1/401; H01Q 21/24; H01P 1/161

(57) ABSTRACT

The invention relates to the field of wireless communication systems operating in a duplex mode for data transmission and reception and in particular to the millimeter-wave communication apparatus with high data throughput. The communication apparatus comprises a dual-polarized antenna with a corresponding first and second ports, optimized for the signal transmission on the first polarization and the signal reception on the second polarization wherein the two polarizations are essentially orthogonal to each other; the first independent filter that is dedicated to pass the signal in the first frequency band and suppress the signals in all other bands and the second independent filter that is dedicated to pass the signal in the second frequency band and suppress the signals in all other bands wherein the two frequency bands are not overlapping; transmitter and receiver radio frequency units for processing of the received or transmitted signal correspondingly to or from the digital modem. The first independent filter is connected to the transmitter radio frequency unit and to the first port of the dual-polarized antenna and pass the transmitted signal from the radio frequency unit to the antenna. The second independent filter is connected to the receiver radio frequency unit and to the second port of the dual-polarized antenna and pass the received signal from the antenna to the radio frequency unit. The invention can be implemented in point-to-point radio relay communication systems to provide combined polarization-division and frequency-division duplexing of the transmission and reception with reduced insertion loss level and higher isolation level between the transmitter and receiver. Implementation of the invention allows to achieve the required isolation level between the transmitter and the receiver with the reduced insertion loss level.

### FIELD OF THE INVENTION

Disclosed invention generally relates to the field of wireless communication systems operating in a duplex mode of the data transmission and reception and, in particular, to the millimeter-wave communication apparatus providing high data throughput.

### BACKGROUND ART

Modern wireless communication systems generally use various duplexing schemes for signal transceiving. The most commonly used are the time-division and the frequency-division duplexing schemes. The first one is based on the separation of the transmitted and received signals over the corresponding non-overlapping time slots. Typically, it is provided with the radio frequency switch that connects a common antenna with a transmitter and a receiver (as it is shown in FIG. 1(a)). The second duplexing scheme is based on the separation of the transmitted and received signals in a frequency domain by utilization of two non-overlapping spectrum bands one for data transmission and one for data reception. Frequency-division duplexing is typically provided by utilization of the special device called diplexer for filtering of the signals to be transmitted or to be received through a common antenna (as it is shown in FIG. 1(b)).

Generally, simultaneous transmission and reception of the signals from a common antenna are impossible in the same time slot and the same frequency band because in that case the low-power received signal will be strongly distorted by the high-power transmitted signal that is typically millions (and even billions) times stronger than the received one.

Rather, the separation of the transmitted and received signals is also possible using the spatial or polarization resources.

Space-division duplexing can be effectively applied only if the receiving antenna is separated from the transmitting one and located at a distance that is sufficient to provide the desired isolation level between the antennas or if any additional isolation devices are applied. However, it is commonly inapplicable in practical communication systems since it leads to a significant increase of the system size and in some cases, requires separate realization of the transmitting and receiving devices. This is especially inefficient for the communication applications where the narrow-beam antennas with high gain and correspondingly large aperture are typically implemented that is necessary to increase the operating distance.

Two orthogonal polarizations are also possible to provide the diversity of the transmitter and receiver channels with a common antenna. This can be implemented by two orthogonal linear polarizations (typically horizontal and vertical) or by two circular polarizations (right-hand or clockwise and left-hand or counterclockwise). The diversity of the signals with orthogonal polarizations is provided by a special device—an orthomode transducer (as it is shown in FIG. 1 (c)). Unfortunately, an isolation level in such a device is typically not sufficient for a pure diversity of the transmitting and receiving signals.

Thus, a wireless communication system providing the data transmission and reception in a duplex mode through a common antenna must generally use special time-division (switch), frequency-division (diplexer) or polarization-division (orthomode transducer) duplexing module. Utilization of such devices is often associated with the design complexity and an increase of the radio frequency circuit insertion loss that is especially critical for microwave and millimeter-wave applications. Moreover, in the majority of the millimeter-wave communication systems diplexers and orthomode transducers are generally realized as separate waveguide modules that are typically bulky and expensive in manufacturing. This significantly increases the overall material costs and provide additional expenses for manufacturing and assembling of the millimeter-wave communication system's transceivers.

For example, a millimeter-wave communication apparatus with the frequency-division duplexing is disclosed in the U.S. Pat. No. 8,090,411. This apparatus includes an antenna with an input port that is used both for signal transmission and signal reception, the first filter dedicated for signal transmission in the first frequency band and signal suppression in all other bands, the second filter dedicated for signal transmission in the second frequency band and signal suppression in all other bands, besides the two frequency bands are not overlapping; transmitter and receiver radio frequency units for processing of the received or transmitted signals to or from the digital modem respectively.

Moreover, the first filter is connected to the transmitter radio frequency unit and the antenna input port and passes the transmitted signal from the transmitter radio frequency unit to the antenna; the second filter is connected to the receiver radio frequency unit and the antenna input port and passes the received signal from the antenna to the receiver radio frequency unit. Both filters and a channel combining device form a diplexer. The antenna is used both for transmission and reception on the same polarization. Thus, the disclosed device requires an implementation of filters with a high quality factor. Such filters regardless of the implementation method introduce additional losses in the microwave signal path. For example, when the filters are realized as waveguide resonators, the insertion loss in the 70-90 GHz frequency range is around 1 dB, that can be considered as acceptable. On the other hand, such a filter is of considerable size and requires precise and expensive manufacturing technologies. Moreover, the filter with the required suppression level typically cannot be realized on the planar substrate (to decrease the size and manufacturing costs) because in that case, the additional insertion loss will be around 5-10 dB or more, that is unacceptable.

Thus, there is a demand for a communication apparatus with an improved diversity between the transmitted and received signals in virtue of implementation of advanced transceiver duplexing schemes that simplifies assembling, provides required isolation level between the transmitted and received signals together with low insertion loss and low manufacturing cost.

### SUMMARY OF THE INVENTION

The object of the current invention is the development of a wireless communication apparatus with combined frequency and polarization diversity between the transmitter and receiver channels.

Technical result of the disclosed invention is in the maintenance of the required isolation level between the transmitter and the receiver with low insertion loss. Mentioned above required isolation level is a level that provides the suppression to a safe level of both in-band and out-of-band transmitter signal and noise leakage to the receiver input. Typically, such isolation level is around 50-100 dB depending on the specific characteristics of the transmitter and receiver (namely, the signal frequency bandwidth, transmitter and receiver noise figures, receiver 1 dB compression point, operational signal-to-noise ratio, etc.). As a result, the disclosed apparatus allows either utilization of standard waveguide-based filters with a simplified structure or implementation of modern low-cost printed technologies which were formerly inapplicable due to high insertion loss level.

Described technical result in the disclosed wireless communication apparatus is achieved by utilization of a dual-polarized antenna with the corresponding first and the second ports optimized for the transmission on the first polarization and for the reception on the second polarization, wherein these polarizations are orthogonal to each other; transmitter and receiver radio frequency units respectively for the processing of the transmitted and received signals from/to the digital modem; further comprising the first filter to pass the signal in the first frequency band and to suppress the signals in all other bands and the second filter to pass the signal in the second frequency band and to suppress the signals in all other bands; herewith the first and the second frequency bands are not overlapping; the first filter that connects the transmitter radio frequency unit and the first port of the dual-polarized antenna provides signal transmission from the transmitter unit to the antenna; and the second filter that connects the receiver radio frequency unit and the second port of the dual-polarized antenna provides signal transmission from the antenna to the receiver unit.

The object of the disclosed invention is achieved by a high isolation level between the transmitter and receiver radio frequency units that is provided by the combination of the dual-polarized antenna cross-polarization level and the isolation between two filters separating the two frequency bands. This facilitates the filter's requirements depending on the antenna cross-polarization level. In particular, it allows to reduce the filters order and therefore to decrease the insertion loss level. Also, there is no more need of combining the transmitter and receiver chains to the common antenna chain similarly to classical communication apparatuses with time-division or frequency-division duplexing.

In one embodiment of the present invention, the transmitter and receiver radio frequency units are each realized on a printed circuit board (PCB).

In another embodiment, both radio frequency units are realized on a common PCB. Elements of the radio frequency chains (i.e. mixers, amplifiers, etc. or an integrated transceiver) are realized as monolithic microwave integrated circuits (MMIC) mounted on a PCB.

In a specific embodiment of the disclosed invention, the first and the second filters are realized on the same PCB with the radio frequency units. Herewith the filters are realized as distributed structures which elements are defined depending on the operational frequency and the most appropriate and effective technology.

In one another embodiment of the disclosed invention, the first and the second filters are realized in a substrate integrated waveguide (SIW) structures on a PCB.

In yet another embodiment, the first and the second filters are formed by a number of coupled resonators realized with the via holes inside the SIW structures.

In yet another embodiment, designed wireless communication apparatus additionally includes transitions from a microstrip line to SIW connecting the filters with radio frequency units and also the filters with the antenna ports. In one another embodiment, the antenna with dual polarizations contains a dual-polarized microstrip radiator realized together with the radio frequency units and filters on the same PCB. Thus, in this embodiment, the transmitter and receiver units, filters based on the SIW technology and the radiator are realized on the common PCB and there is no need of any additional modules or elements to provide duplex operation. This approach significantly decreases the apparatus overall cost and size and simplifies the assembling procedure. Microstrip dual-polarized radiator contains two input ports each providing operation on the one or the other orthogonal polarization.

In some specific embodiments, a dual-polarized radiator can be based on a microstrip antenna with direct feeding of microstrip lines to the radiating element (edge-feed microstrip antenna), a proximity coupled microstrip antenna, a microstrip antenna electromagnetically coupled with the feeding microstrip line through the slot aperture in the ground plane (aperture-coupled microstrip antenna), a microstrip antenna with signal feeding using a printed microstrip line realized on one of internal metallization layers of the PCB between radiating element (patch) and the ground plane, a microstrip antenna with feeding through metalized via holes connecting microstrip lines and radiating patch. Herewith the radiating patch can be of different shape, i.e. rectangular, square, circular, elliptical, triangular, etc.

In yet another specific embodiment of the disclosed invention, a dual-polarized antenna is an integrated lens antenna containing a dielectric lens and a dual-polarized primary radiator realized on a PCB mounted directly on the lens flat surface. In this embodiment, the dual-polarized lens antenna provides high gain value and therefore long operational distance for high throughput data transfer. Herewith the dual-polarized primary radiator can be realized as a microstrip antenna of any structure including abovementioned structures. Installation of the primary radiator on the lens surface guarantees the best characteristics of the lens antenna.

In other embodiments, other types of dual-polarized antennas and primary radiators can be implemented. For example, parabolic dish antennas with a dual-polarized primary radiator that can be based on a horn antenna.

In one more embodiment, the first and the second filters are based on metalized waveguides. In more specific embodiments, the designed wireless communication apparatus contains waveguide-to-microstrip transitions between radio frequency units realized on a PCB and the abovementioned filters. In some embodiments, the dual-polarized antenna can also include an orthomode transducer for polarization diversity of the two orthogonally polarized signals wherein the orthomode transducer is connected to the first and the second filters.

In another specific embodiment, quality factors and therefore orders of the first and the second filters are different. In that case, insertion loss is reduced in the radio frequency chain containing a lower order filter.

In yet another embodiment, the first and the second polarizations are linear polarizations orthogonal to each other.

In one another embodiment, the first and the second polarizations are right-hand (clockwise) and left-hand (counterclockwise) circular polarizations orthogonal to each other. However, in this case, obviously, the polarization diversity is much lower than in the first case.

In one specific embodiment, the wireless communication system is optimized for operation in the 71-76 GHz and 81-86 GHz frequency bands.

In another embodiment, the wireless communication apparatus is optimized for operation in the 57-59.5 GHz and 61.5-64 GHz frequency bands. This frequency bands are allocated in many countries for point-to-point communication systems with high data rate, which are very sensitive to the implementation of additional orthomode transducers and diplexers that contribute additional insertion loss. The isolation level between the transmitter and receiver in such systems is typically around 60 dB and more that can be effectively provided in the designed wireless communication apparatus.

In another specific embodiment, the antenna of the wireless communication apparatus provides gain value of more than 38 dBi for each polarization, that is typically enough to guarantee high operational distance for a millimeter-wave signal with high throughput.

In yet another embodiment, the disclosed apparatus is optimized for implementation in radio relay point-to-point communication systems and guarantees data rates exceeding 1 Gbit per second.

### BRIEF DESCRIPTION OF THE DRAWINGS

Components, features, and advantages of the disclosed invention will be apparent from the following description and drawings corresponding to the specific embodiments.

FIG. 1.—known communication apparatuses that provide signal transmission and reception in a duplex mode

FIG. 1(a)—block diagram of the apparatus with time-division duplexing;

FIG. 1(b)—block diagram of the apparatus with frequency-division duplexing;

FIG. 1(c)—block diagram of the apparatus with polarization-division duplexing;

FIG. 2.—general block diagram of the communication apparatus according to one embodiment of the current invention;

FIG. 3—non-overlapping frequency bands of the transmitted and received signals in the communication apparatus with frequency-division duplexing;

FIG. 4.—photo of the transmitter and receiver radio frequency units realized on separate PCBs that are mounted on a waveguide structure containing duplexing filters;

FIG. 5.—substrate integrated waveguide (SIW) structure realized on a PCB;

FIG. 6(a).—structure of a filter based on a SIW realized on a PCB;

FIG. 6(b).—filter based on a SIW structure with transitions to microstrip lines that are connected to an input and an output of the filter;

FIG. 7.—various realizations of dual-polarized microstrip antennas:

FIG. 7 (a).—microstrip antenna with a direct feeding of the microstrip lines to the radiating patch;

FIG. 7 (b).—microstrip antenna with the feeding microstrip lines realized on one of the internal layers between a radiating patch and a ground plane;

FIG. 7 (c).—microstrip antenna with electromagnetic coupling of the feeding microstrip lines and the radiating patch through the coupling slot apertures in a ground plane;

FIG. 7 (d).—microstrip antenna with a feeding realized through metalized via holes connecting microstrip lines and a radiating patch;

FIG. 8.—integrated lens antenna with a dual-polarized primary radiator realized on a PCB;

FIG. 9.—PCB according to one of the embodiments of the disclosed invention, containing a dual-polarized microstrip antenna and two filters based on a SIW and connected to transmitter and receiver radio frequency units;

FIG. 10.—block diagram of the wireless communication apparatus according to one of the embodiments containing an orthomode transducer;

Numbers on the figures represent the following elements:

10—digital modem; 20—digital-to-analog converter; 30—analog-to-digital converter; 40—transmitter radio frequency unit; 41—transmitter; 42—PCB; 43—metalized via holes; 44—bottom metallization layer; 45—top metallization layer; 46—coupled resonators; 47—microstrip line; 48—microstrip-to-SIW transitions; 50—receiver radio frequency unit; 51—receiver; 52—PCB; 53—radiating element; 54—the first port; 55—the second port; 56—radio frequency ground plane; 61—switch; 62—diplexer; 63—orthomode transducer; 70—antenna with single polarization; 79—antenna element; 80—metal waveguide structure; 81—the first independent filter; 82—the second independent filter; 90—dual-polarized antenna; 91—primary radiator; 92—lens; 100—communication system device; 200—wireless communication apparatus; 300—wireless communication apparatus; 400—wireless communication apparatus; 500—wireless communication apparatus.

### DETAILED DESCRIPTION OF THE INVENTION

The present invention can be completely understood from the following description of some specific embodiments of the wireless communication apparatus with combined frequency and polarization diversity between the transmitter and receiver channels on the examples of the apparatus implementation in the millimeter-wave point-to-point communication systems with high data throughput.

The wireless communication apparatus according to the disclosed invention provides required isolation level between the transmitter and receiver with reduced insertion loss and also with less labor and resources expenses for manufacturing and assembling of the millimeter-wave transceiving device.

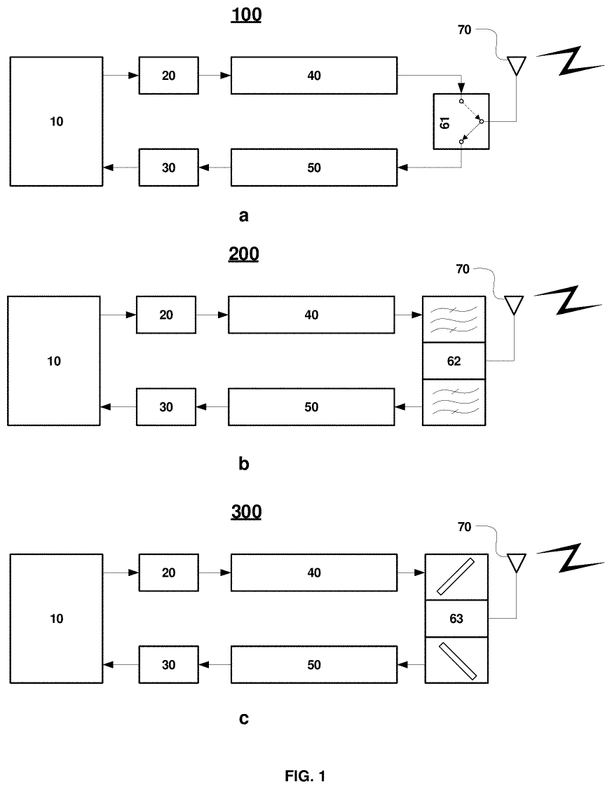

FIG. 1. shows block diagrams of the known from the background art communication apparatuses that implement various approaches for the diversity of the transmitted and the received signals. The device (100) that is shown in FIG. 1(a), uses the time-division diversity scheme (duplexing). It consists of a digital modem (10), performing required digital signal processing algorithms, a digital-to-analog converter (DAC) (20) and an analog-to-digital converter (ADC) (30), radio frequency units of the transmitter (40) and the receiver (50), an antenna with single polarization (70) and a duplexing module that in current realization is represented with a switch (61). The switch (61) provides physical connection of the radio frequency units and the common antenna in the predefined time slots.

The device (100) that is shown in FIG. 1(a) is a classical transceiver with time-division duplexing, that is commonly used in different communication systems. FIG. 1(b). illustrates a wireless communication apparatus (200) that implements the frequency-division duplexing scheme of data transmission and reception. It consists of the same elements except for a diplexer (62) instead of a switch (61)

The diplexer (62) provides diversity of the signals that occupy different frequency bands. The wireless communication apparatus (300) with polarization diversity of the transmission and reception is shown in FIG. 1 (c). It uses an orthomode transducer (63) as a duplexing module. The transducer separates two signals that have orthogonal polarizations for transmission and reception by the common antenna.

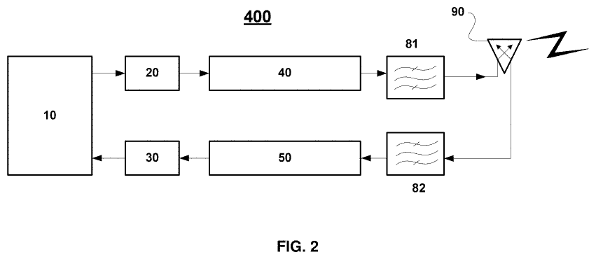

FIG. 2 shows a block diagram of the wireless communication apparatus (400) according to one embodiment of the disclosed invention. Herewith a digital modem (10) is connected to a DAC (20) and an ADC (30) and performs generation (modulation) of the digital signal for further transmission and also the demodulation of the received signal. The transmitted signal is further converted by the DAC (20) to the analog signal that occupies the band close to zero or some specified low intermediate frequency. The ADC (30) provides an opposite operation with the received signal while it will be transferred to the digital modem for signal processing.

The DAC (20) and the ADC (30) are connected to the transmitter (40) and the receiver (50) radio frequency units correspondingly. The unit (40) transfer the analog signal to a high carrier frequency and vice versa the unit (50) forms a low frequency baseband signal from the received radio frequency signal. All abovementioned transformations are standard for known digital wireless communication apparatuses including millimeter-wave point-to-point systems. In these known communication apparatuses, duplex mode is provided by the duplexing module with a common port that is connected to an antenna as it is described above.

The designed wireless communication apparatus (400) is characterized by the presence of two independent filters (81) and (82) placed between the dual-polarized antenna (90) and the radio frequency units (40) and (50). The first independent filter (81) is designed to pass the transmitted signal to the first port (54) of the dual-polarized antenna (90) in the first frequency band F1, allocated for the communication system with frequency-division duplexing and the second independent filter (82) that is designed to pass the signal received by the dual-polarized antenna (90) from second port (55) of the antenna (90) in the frequency band F2. Frequency bands F1 and F2 are not overlapping. The dual-polarized antenna (90) has two ports each one for excitation of one of two orthogonal polarizations. The first polarization is dedicated for signal transmission in the first frequency band F1 and the second polarization is for signal reception in the second frequency band F2.

The advantage of the considered embodiment of the disclosed invention is that the isolation level between the transmitted and received signals is provided both by filters (81) and (82) and the cross-polarization discrimination of the dual-polarization antenna (90). This wireless communication apparatus provides a lower level of insertion loss due to the implementation of the reduced order filters and an effective dual-polarized antenna.

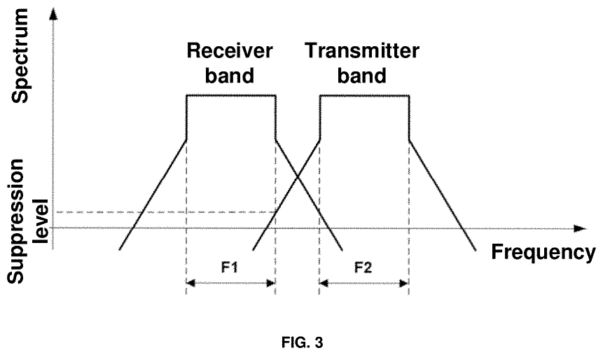

The isolation level between the transmission and reception channels can be defined as it is shown in FIG. 3 wherein the normalized spectrums of the transmitted (Tx) and received (Rx) signal are represented. They occupy nonoverlapping frequency bands F1 and F2 correspondingly. As it can be seen in FIG. 3, the transmitted signal has the maximum of radiated power in the frequency band F1 but also some level of unwanted out-of-band radiation (or noise) in the neighboring frequencies. Due to this, some transmitter noise can penetrate into the receiver chain in the frequency band F2 and therefore it can lead to significant degradation of the received signal quality. The level of the described transmitter's power penetration to the receiver channel in the frequency band F2 is completely defined by the selective circuits in the transceiver front-end and typically should be in the range of −50 . . . −100 dB and lower relative to the transmitter signal power. For example, in the considered embodiment of the disclosed invention, the isolation level of 60 dB can be achieved with the combination of 30 dB isolation level in the filters and 30 dB level of the dual-polarization antenna (90) cross-polarization. Also, any other ratio between the filters isolation and the antenna cross-polarization is possible.

In one embodiment of the disclosed invention, the radio frequency units of the transmitter (40) and the receiver (50) are realized on the printed circuit or ceramic boards.

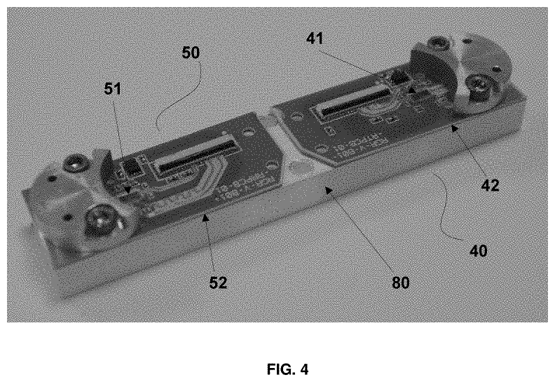

One example of such an embodiment of the radio frequency units (40) and (50) is presented in FIG. 4. The main functional elements of the radio frequency units in this embodiment are MMICs of the transmitter (41) and the receiver (51). These MMICs in the current example operate in the frequency range of 57-64 GHz and are bare die MMICs. The transmitter (41) and receiver (51) radio frequency MMICs are mounted on two separate PCBs (42) and (52) using wire-bonding technology forming the radio frequency transmitter (40) and receiver (50) units.

Connectors, control and supply circuits are installed on the PCBs (42) and (52). Microwave lines that are transmitting a signal on a carrier frequency are connected through waveguide-to-microstrip transitions to the filters (81) and (82) that are realized in a metal waveguide structure (80).

One another advantage of the designed wireless communication apparatus is a reduction of overall resource and labor expenses for manufacturing and assembling of the millimeter-wave transceiver. This is effectively provided in the described embodiment were the filters (81 and 82) are realized using printed technology on the same PCB together with transmitter (40) and receiver (50) radio frequency units.

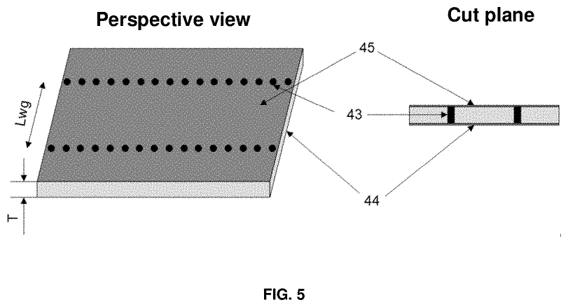

For example, a planar filter can be realized within the SIW structure as it is shown in FIG. 5. SIW is a rectangular waveguide that is formed inside the PCB structure (42) with the two metallized layers (a top metalized layer (45) and a bottom metalized layer (44)) and two parallel rows of metalized via holes (43) with small pitch distance needed to prevent the leakage of the propagating through the waveguide wave. Thus, SIW is a rectangular dielectric-filled waveguide and therefore its main advantage is in a realization using standard low-cost PCB technology. SIW structure can be fabricated on any PCB (including multilayer ones) between any two metallization layers. Length L_{WG} and width T (equal to board thickness between two metallization layers (44) and (45)) of the SIW cross section completely define a set of cutoff frequencies for each of the propagating modes of the electromagnetic field and, therefore, operational bandwidth where the only dominant TE₁₀ mode is propagating along the waveguide. In practical realizations, for example, within the 60-90 GHz frequency range, the SIW width T is typically around 0.1-0.5 mm and the length L_{WG} is around several millimeters (certain value depends on the dielectric properties of the PCB material). Thus, SIW size is lower than in conventional hollow metal waveguides.

One another advantage of the designed wireless communication apparatus is a reduction of overall resource and labor expenses for manufacturing and assembling of the millimeter-wave transceiver. This is effectively provided in the described embodiment were the filters (81 and 82) are realized using printed technology on the same PCB together with transmitter (40) and receiver (50) radio frequency units.

According to one of the embodiments of the disclosed invention, the first (81) and the second (82) filters are the SIWs that consist of a group of coupled resonators (46). These resonators (46) are formed by the number of metalized via holes (43) in the SIW structure.

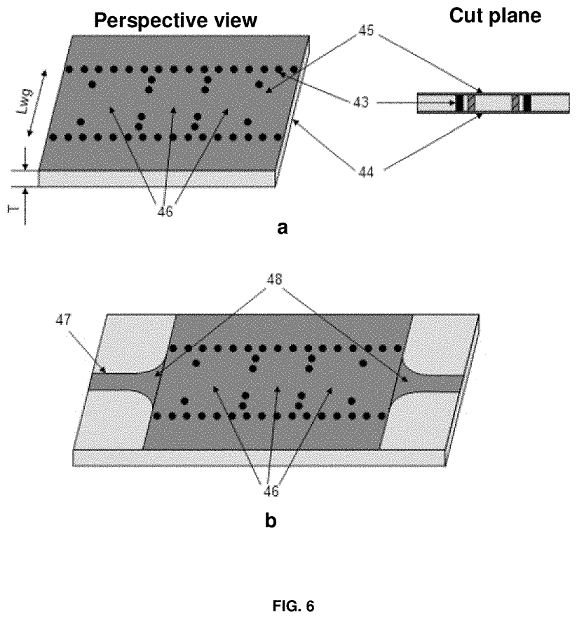

The example of the filter according to the described embodiment is presented in FIG. 6(a). This figure shows the metalized via holes (43) forming the coupled resonators (46) and realized in the SIW structure. Each resonator is, in particular, a part of the waveguide channel confined by the number of additional via holes placed within the waveguide channel. These via holes form partial walls (inductive irises) with gaps (windows) realized within the waveguide channel. The resonant frequency and the quality factor of each resonator are completely defined by the distance between metalizes via holes (43) placed alongside the waveguide channel and the size of the windows between via holes located in the perpendicular cross-section of the waveguide. Equivalent electrical resonant wavelength generally corresponds to the twice resonator length. Resonator quality factor is increasing with reduction of the window size. Typically for the considered multi-resonance circuits the window size, quality factor, and resonant frequency are selected within the optimization procedure using the specialized software during electromagnetic simulation. It allows to take into account all complex effects associated with the mutual influence of the coupled resonators that cannot be considered analytically.

The number of coupled resonators (46) in each filter defines the filter order. With the filter order growth, it is possible to The number of coupled resonators (46) in each filter defines the filter order. With the filter order growth, it is possible to increase the quality factor and therefore the isolation level in a stopband but only with an increase in the insertion loss in a passband. This is the main reason why the SIW-based diplexers that can provide the required high isolation level for the communication systems with only frequency-division duplexing also have an unacceptable level of insertion loss. Typically, for the millimeter-wave communication systems, the filter orders from the 7^{th} to 12^{th}-14^{th} should be implemented to provide the required isolation levels of 50-100 dB. In the presented invention filters order and therefore the insertion loss can be significantly reduced depending on the dual-polarized antenna (90) cross-polarization level.

FIG. 6(b) shows the structure of the filter based on the SIW technology according to another embodiment wherein the filter input and output are connected to microstrip-to-SIW transitions (48) to microstrip line (47). Transitions (48) to microstrip line (47) (or alternatively to any other type of planar transmission line) are required to pass the signal to various planar radiators and MMICs that form radio frequency units. For example, the microstrip line (47) serves to excite microstrip antennas, that can be easily optimized to support radio frequency communication on two polarizations.

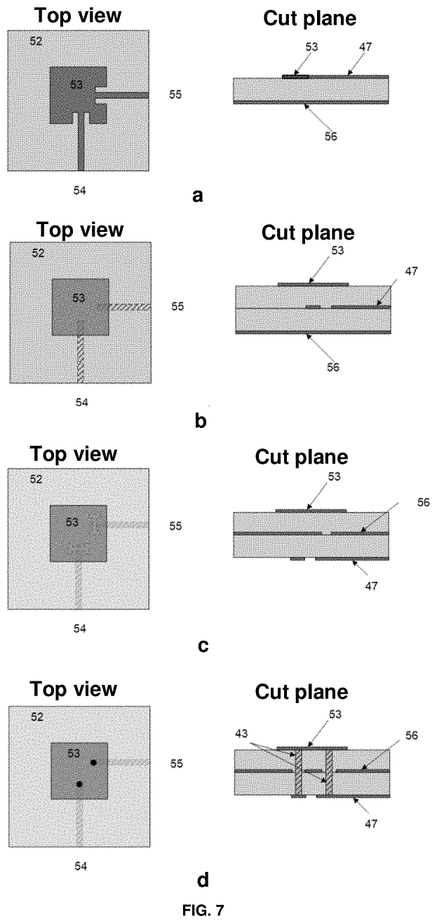

In various embodiments, different dual-polarized microstrip antennas can be used. FIG. 7(a) shows a microstrip antenna with direct signal feeding to the radiating element (53) with the microstrip lines (47). FIG. 7(b) shows a microstrip antenna with the feeding microstrip line (47) realized on the internal metallization layer of PCB (52) between the radiating element (53) and a ground plane (56). FIG. 7(c) illustrates a microstrip antenna with electromagnetic coupling of the radiating element (53) and feeding microstrip lines (47) through the slot apertures (56) in the radio frequency ground plane (56). FIG. 7 (d) shows a microstrip antenna with the signal feeding through the metalized via holes (43) connecting feeding microstrip lines (47) and the radiating element (53).

Microstrip antennas are very suitable for manufacture on the PCBs and have good characteristics and are robust to manufacturing inaccuracies. In one embodiment of the disclosed invention, a dual-polarized microstrip antenna is realized on the same board with the radio frequency units and filters.

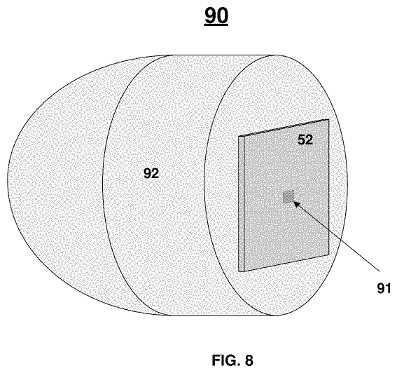

In one another embodiment of the designed wireless communication apparatus, the dual-polarized antenna (90) is a lens antenna containing a dielectric lens (92) and a dual-polarized primary radiator (91) realized on the PCB and mounted on the lens (92) flat surface as it is shown in FIG. 8. In this embodiment, the antenna (90) has high gain value and therefore provides an increase of the communication system operational distance.

Utilization of the integrated lens antenna makes it possible to provide additional advantages that are an increase of the aperture efficiency, simplification of the assembling and reduction of the transceiver dimensions. This is especially of interest for millimeter-wave radio frequency communication applications where the utilization of the high gain antennas is obligatory (for example in radio relay systems). The lens in various embodiments can be fabricated of a homogeneous dielectric material, e.g. polytetrafluoroethylene, rexolite, quartz glass, polyethylene, polyamide, polycarbonate, highly resistive silicon, etc. In this embodiment, the PCB is mounted on the lens flat surface with the screws or any other way. It can be additionally mentioned that the lens has a collimating part that proves the narrow beam focusing and an extension part containing an abovementioned flat surface. The extension does not contribute to a narrow radiation pattern beam and therefore its shape can be modified in a different manner in order to simplify the integration of the antenna with the wireless communication device enclosure.

In one specific embodiment of the disclosed invention, the primary radiator (91) of the integrated lens antenna is a microstrip antenna. That radiator when mounted on the lens (92) surface provides very low back radiation level because it contains a large metal shielding that acts as a microwave ground plane. Such radiator properties provide an increase of the lens antenna gain.

Similar to the radiators that are shown in FIG. 7, the primary radiator can be realized using various signal feeding options. The only factor that should be considered in the development and optimization is a radiation of the primary radiator into a lens with specific dielectric properties instead of the vacuum. However, it is possible to implement any other dual-polarized primary radiators.

In one of the embodiments, a dual-polarized primary radiator is realized on the same PCB with the radio frequency units and filters, wherein the PCB is mounted on the lens flat surface. This embodiment is one of the most practical for the communication systems with frequency-division duplexing because it fully excludes the use of the traditional metal waveguide filters and diplexer.

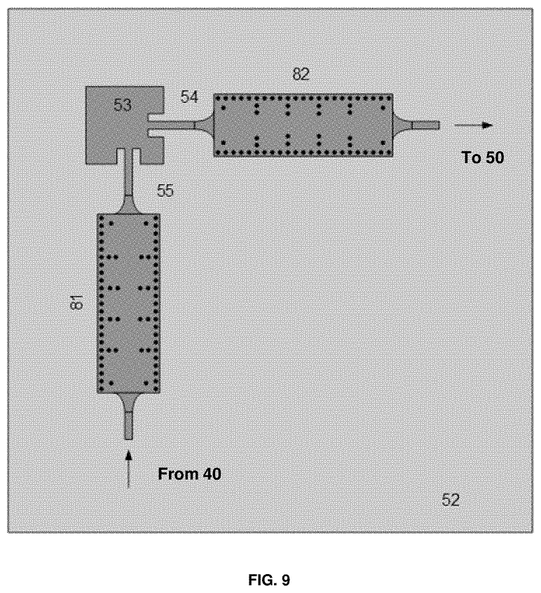

Example of the PCB (52) containing a microstrip antenna with direct signal feeding using the microstrip lines (47) and two filters (81) and (82) based on the SIW with corresponding microstrip-to-SIW transitions (48) is shown in FIG. 9. Herewith the radio frequency transmitter (40) and receiver (50) units are not shown since their realizations and method of the installation on the PCB can be different. In the presented embodiment the lens is placed on the same PCB side as the primary radiator (91) that radiates the signal into the lens body. In this case, additional cavities can be realized on the lens flat surface in order to provide an installation of the radio frequency MMIC transmitter (40) and receiver (50) units on the PCB (52). These cavities can be also covered with metal to prevent parasitic radiation inside the lens body caused by the MMIC interconnections with the PCB. In some other embodiments, other primary microstrip radiators can be implemented including, for example, the ones with feeding through coupling slots or metalized via hole as it is shown in FIG. 7(c) and FIG. 7(d) correspondingly. In these cases, the filters as the transmitter and receiver MMICs will be located on the opposite side of the PCB relatively to the radiating element (53) and therefore, to the lens. In that case, there is no need for additional cavities on the lens flat surface.

In other embodiments of the designed communication apparatus, other types of dual-polarized antennas with high gain can be implemented. These antennas can be represented by other types of lens antennas (e.g. thin lens, Luneberg lens, etc.), parabolic reflector antennas, Cassegrain antennas with dual-polarized primary radiators which can be in some embodiments represented with a circular or rectangular horn antenna.

In yet another embodiment, the first filter (81) and the second filter (82) are realized as metal waveguide components. To transmit the signal from that filters to the microstrip lines (47) and back the microstrip-to-SIW transitions (48) can be implemented between the waveguide filters (81) and (82) and transmitter (40) and receiver (50) radio frequency units realized on the PCBs.

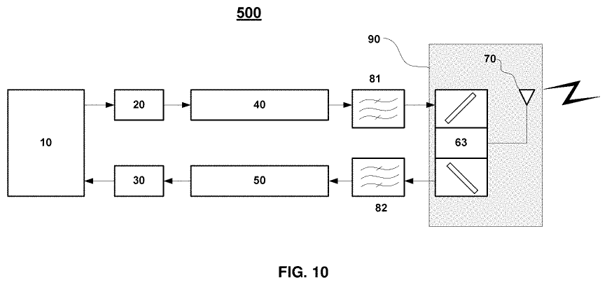

In one more specific embodiment, the dual-polarized antenna (90) contains the orthomode transducer (63) used to separate the orthogonally-polarized signals, wherein the transducer (63) is connected to the first (81) and the second (82) filters. In that case, the orthomode transducer (63) is also based on the metal waveguides. In this embodiment antenna element (79) has only one input port for both polarizations (that means that two orthogonally-polarized signals can be transmitted through that port). A general block diagram or the designed wireless communication apparatus (500) according to the described embodiment is presented in FIG. 10.

According to another embodiment, the first and the second filters that are connected to the transmitter and receiver radio frequency units can have different quality factors and therefore different filter order. It provides an additional advantage of the insertion loss reduction in the path (either transmitter or receiver) where the isolation requirements are relaxed, and the lower order filter is implemented.

In more specific embodiments, the first and the second polarizations are the linear polarizations orthogonal to each other. In other embodiments, the first and the second polarizations are orthogonal right-hand (clockwise) and left-hand (counterclockwise) polarizations. It should be mentioned that increase of the cross-polarization isolation level allows reducing the insertion loss in the filters.

In one aspect of the present invention, the wireless communication system is optimized for operation in the paired frequency range 71-76/81-86 GHz. In another aspect, the wireless communication system is optimized for operation in the paired frequency range 57-59/61.5-64 GHz. These frequency ranges are allocated in many countries for high-data rate radio relay point-to-point communication systems. Required isolation level between the transmitter and the receiver in such systems is typically more than 60 dB, that can be easily achieved in the designed wireless communication system.

In one more specific embodiment, the dual-polarized antenna provides the gain level of more than 38 dBi for each polarization. The radiation pattern half-power beamwidth of the antenna with such gain level is not more than 2 degrees that provide low interference level between two neighboring wireless communication devices even if they are closely spaced. High gain value is also required to provide a long operational distance of a communication system with high data throughput.

The designed communication apparatus according to any described embodiment can be optimized for operation in the point-to-point radio relay system with peak throughput over 1 Gbit per second.

The current invention is not limited by the described embodiments that are disclosed only in description purposes and cover all possible modifications and variations within the scope and the spirit of the invention as it is defined by the foregoing claims.

1. Wireless communication apparatus comprising:
a dual-polarized antenna with corresponding first and second ports, adapted for a signal transmission on the first polarization and signal reception on the second polarization, wherein two polarizations are orthogonal to each other;
transmitter and receiver radio frequency units for signal processing of the transmitted and received signal correspondingly from/to a digital modem;
those units additionally including:
the first and the second independent filters realized in the SIW structure as a combination of coupled resonators formed by metalized via holes,
the first independent filter providing signal transmission in the first frequency band and signal suppression in all other bands; and the second independent filter providing signal transmission in the second frequency band and signal suppression in all other bands wherein the two frequency bands are not overlapping;
wherein the first independent filter is connected to the transmitter radio frequency unit and the first port of the dual-polarized antenna and is realized to pass the transmitted signal from the radio frequency unit to the antenna and the second independent filter is connected to the receiver radio frequency unit and the second port of the dual-polarized antenna and is realized to pass the received signal from the antenna to the receiver radio frequency unit.

2. Communication apparatus according to claim 1, wherein each of the transmitter and receiver radio frequency units is realized as a module on the PCB.

3. (canceled)

4. (canceled)

5. Communication apparatus according to claim 1, additionally containing microstrip-to-SIW transitions connecting the filters to the radio frequency units and also the filters to the antenna ports.

6. Communication apparatus according to claim 1, wherein the first and the second independent filters are realized on the same PCB with the radio frequency units.

7. Communication apparatus according to claim 1, wherein the dual-polarized antenna is a microstrip antenna realized on the same PCB with radio frequency units and filters.

8. Communication apparatus according to claim 1, wherein the dual-polarized antenna is an integrated lens antenna containing a dielectric lens and a primary radiator realized on the PCB and mounted on the lens flat surface.

9. Communication apparatus according to claim 8, wherein the primary dual-polarized radiator is a microstrip antenna.

10. Communication apparatus according to claim 8, wherein the primary radiator is realized on the same PCB with the filters and radio frequency units.

11. Communication apparatus according to claim 1, wherein the dual-polarized antenna is a parabolic dish reflector with a primary radiator.

12. Communication apparatus according to claim 11, wherein the primary radiator is a horn antenna.

13. (canceled)

14. (canceled)

15. Communication apparatus according to claim 1, wherein the dual-polarized antenna contains an orthomode transducer for separation of the orthogonally-polarized signals that is connected to the first and the second independent filters.

16. Communication apparatus according to claim 1, wherein the first and the second independent filters have different quality factors and orders.

17. Communication apparatus according to claim 1, wherein the first and the second polarizations are orthogonal linear polarizations.

18. Communication apparatus according to claim 1, wherein the first frequency band is 71-76 GHz and the second frequency band is 81-86 GHz.

19. Communication apparatus according to claim 1, wherein the first frequency band is 57-59.5 GHz and the second frequency band is 61.5-64 GHz.

20. Communication apparatus according to claim 1, wherein the suppression of the transmitter signal on the receiver radio frequency unit exceeds 60 dB.

21. Communication apparatus according to claim 1, wherein the dual-polarized antenna has the gain of more than 38 dBi for each polarization.

22. Communication apparatus according to claim 1, wherein it is realized with the possibility of implementation in the point-to-point radio relay communication systems with the data throughput exceeding 1 Gbit per second.
